(19) United States
(12) Patent Application Publication
(10) Pub. No.: US 2009/0096748 A1
(43) Pub. Date: Apr. 16, 2009

(54) INPUT DEVICE WITH PHYSIOLOGICAL MEASURING FUNCTION

(76) Inventor: Tung-Ke WU, Taipei (TW)

Correspondence Address: Muncy, Geissler, Olds & Lowe, PLLC, P.O. BOX 1364, FAIRFAX, VA, 22038-1364, US

(21) Appl. No.: 12/202,867

(22) Filed: Sep. 2, 2008

(30) Foreign Application Priority Data
Oct. 12, 2007 (TW) 096138259

(51) Int. Cl. G09G 5/08

(52) U.S. Cl. 345/157; 341/20

(57) ABSTRACT

An input device with the physiological measuring function includes a housing, a position-adjustable mechanism and a sensor module. The housing has a handheld part and an opening. The position-adjustable mechanism is disposed in the housing and a part of the position-adjustable mechanism is exposed from the opening. The sensor module and the position-adjustable mechanism are joined together for traction.

### CROSS REFERENCE TO RELATED APPLICATIONS

This Non-provisional application claims priority under 35 U.S.C. §119(a) on Patent Application No(s). 096138259 filed in Taiwan, Republic of China on Oct. 12, 2007, the entire contents of which are hereby incorporated by reference.

### BACKGROUND OF THE INVENTION

1. Field of Invention

The invention relates to an input device and, in particular, to an input device with the physiological measuring function.

2. Description of the Related Art

Accompanying with the progressive of technology, the computer has became one of the indispensable devices in our lives. Taking the medical treatment as an example, the patient must be measured by the instruments in the health center for continuously measuring the physiological signals and showing the results on the monitor. When the shown physiological signals are abnormal, the professional medical members can decide to do some proper medical actions according to the results shown on the monitor. However, this medical treatment needs many professional medical members and is very expensive. Furthermore, it is difficult to apply this medical treatment to the patients in remote districts. Accordingly, the present medical services are developed from the traditional hospital or clinic therapy to the in-home therapy. For example, the in-home therapy needs the sphygmomanometer, ear thermometer and blood glucose meter, but not limited to these. These are cooperated with the computer, video conference and Internet to carry out the distance medical treatment.

As shown in FIG. 1, a conventional input device 10 with the physiological measuring function includes a housing 11 and a sensor module 13. The housing 11 has a handheld part 111, and the sensor module 13 is fixed at a specific position on the handheld part 111. When the user uses the input device 10 to measure the heartbeat, he must continuously press the sensor module 13. However, this may cause the tiredness and inconvenience of user's hand. In addition, the dirt and hand sweat may be remained on the surface of the sensor module 13, which will affect the accuracy of the measuring result. Moreover, the sensor module 13 is usually disposed at a fixing position and can not be moved, so that the user may hold on incorrect position due to the personal conditions and habits, thereby causing the measuring error.

The utility of the input device with the measuring functions is usually improved by increasing the amount of the sensor modules so as to enlarge the measuring area. However, this method also increases the cost of the input device. Besides the sufficient measuring area, the input device also has to fit the using habits of the users. Thus, the input device must provide better handheld feeling and prevent the dirt from being remained thereon, which may affect the accuracy of the measuring results.

### SUMMARY OF TIE INVENTION

An object of the invention is to provide an input device with the physiological measuring function having a sensor module that is position adjustable according to different physiological conditions and user habits, so that the measuring area can be increased without adding more sensor modules.

Another object of the invention is to provide an input device with the physiological measuring function having a light permeable handheld part, so that the user can not directly contact the sensor module, thereby preventing the sweat or dirt from being remained on the sensor module to affect the following measuring results.

To achieve the above object, the invention discloses an input device including a housing, a position-adjustable mechanism and a sensor module. The housing has a handheld part and an opening. The position-adjustable mechanism is disposed in the housing, and a part of the position-adjustable mechanism is exposed from the opening. The sensor module is joined together with the position-adjustable mechanism for traction.

In a preferred embodiment of the invention, the opening of the input device is disposed on the handheld part, the handheld part is disposed on one side surface of the housing, and the sensor module is exposed from the opening. The sensor module is connected with the position-adjustable mechanism, so that the sensor module can be adjusted to a suitable position while adjusting the position-adjustable mechanism within the opening.

In another preferred embodiment of the invention, the opening of the input device can be disposed on a bottom of the housing, and the handheld part is light permeable. Similarly, the sensor module is connected with the position-adjustable mechanism, so that the sensor module can be adjusted to a suitable position while adjusting the position-adjustable mechanism through the bottom of the housing. Thus, the sensor module can measure the user through the light-permeable handheld part.

As mentioned above, the input device with the physiological measuring function of the invention has the position-adjustable mechanism for adjusting the position of the sensor module according to different physiological conditions and habits of the users. Thus, it is unnecessary to add the amount of the sensor module for different users. Compared with the prior art, the sensor module of the invention is not directly contact with the user, so that the surface of the sensor module can be kept cleaner so as to ensure the reliability of the measuring results.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional input device with the measuring function;

FIG. 2 is a schematic diagram of an input device with the physiological measuring function according to a preferred embodiment of the invention;

FIG. 3 is a partial sectional diagram according to the preferred embodiment of the invention;

FIGS. 4A to 4B are schematic diagrams showing different measuring aspects according to the input device of the invention;

FIG. 5 is a schematic diagram of another input device with the physiological measuring function according to the preferred embodiment of the invention;

FIG. 6 is a partial sectional diagram of the input device of FIG. 5; and

FIG. 7 is a schematic diagram showing the signal processing between the sensor module and the electronic components.

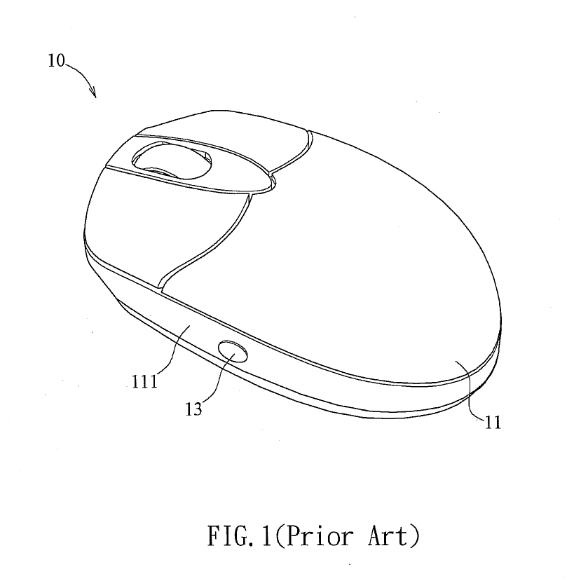

### DETAILED DESCRIPTION OF THE INVENTION

The present invention will be apparent from the following detailed description, which proceeds with reference to the accompanying drawings, wherein the same references relate to the same elements.

In the following illustrations, the sensor module of the input device measures the photo plethysmographic (PPG). The PPG can calculate the continuous waveform variations of the blood volume inside the blood vessels according to the light refractiveness and refraction angles. It can be found that the blood volume, pulse and blood pressure in the blood circulation system are closely linked. Thus, the sensor module of the input device with the physiological measuring function in the following embodiment is a photo plethysmographic (PPG) sensor module.

To be noted, the physiological measuring function of the embodiment is to measure the physiological signals such as heartbeat, pulse, sweat, skin temperature, blood signal, oxygen saturation (SpO₂), muscle tone or blood pressure.

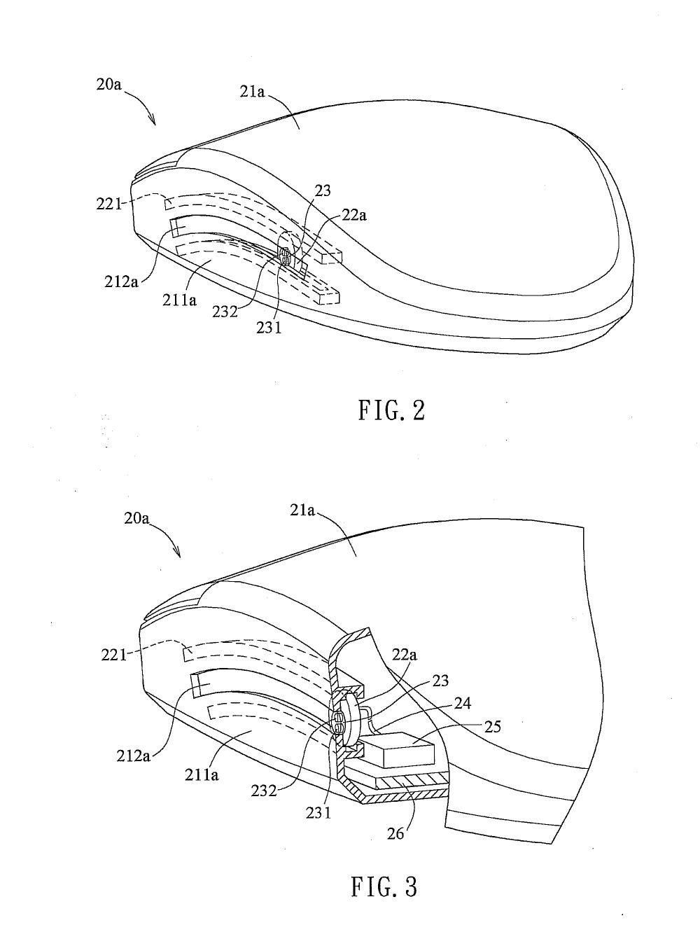

With reference to FIGS. 2 and 3, an input device 20a is a mouse for an example, but not limited to it. The input device 20a includes a housing 21a, a position-adjustable mechanism 22a and a sensor module 23.

A handheld part 211a having an opening 212 is disposed on a side surface of the housing 21a. The position-adjustable mechanism 22a is disposed in the housing 21a, and a part of the position-adjustable mechanism 22a is exposed from the opening 212a. The position-adjustable mechanism 22a can be moved within the opening 212a, such as a rectangular opening 212a, so as to adjust the position thereof. In the embodiment, the sensor module 23 is joined together with the position-adjustable mechanism 22a for traction. Thus, the position of the sensor module 23 can be adjusted according to the position-adjustable mechanism 22a. In addition, the sensor module 23 can be exposed from the opening 212a. Thus, when the user holds the handheld part 211a of the input device 20a, he can adjust the sensor module 23 to the desired position so as to ensure the reliability of the measuring results.

In the embodiment, the position of the position-adjustable mechanism 22a can be adjusted through the tracks 221 inside the housing 21a, but not limited to it. In addition, the tracks 221 and the housing 21a can be integrally formed, and the housing 21a can be made of the opaque material. The position of the position-adjustable mechanism 22a can be adjusted by shifting, rotating or shifting-rotating.

The PPG sensor module 23 includes at least one light-emitting element 231 and a sensor element 232. The light-emitting element 231 and the sensor element 232 can be integrated in the same module. In the embodiment, the light-emitting element 231 can be a light-emitting diode (LED) or an organic light-emitting diode (OLED). The sensor element 232 can be a photo diode (PD), a charge coupling device (CCD) or a complementary metal-oxide semiconductor (CMOS). The sensor module 23 can transmit signals through a wire 24 and an electronic component 25, but not limited to it. Then, the electronic component 25 can be further coupled to a circuit board 26.

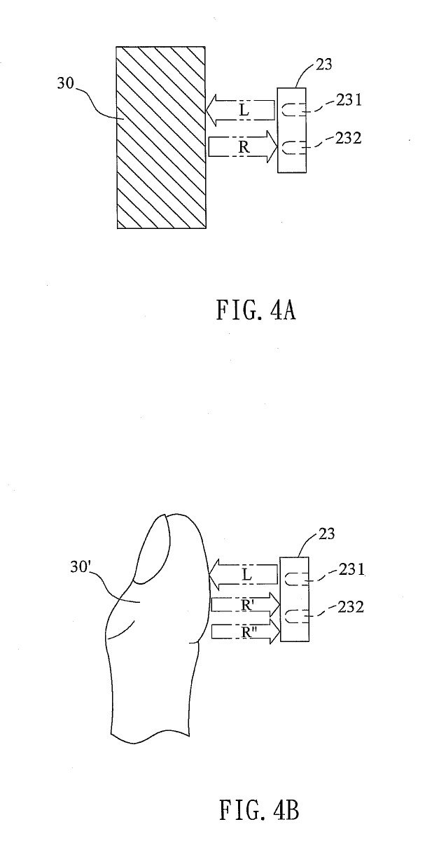

With reference to FIG. 4A, the light-emitting element 231 of the input device 20a emits a light beam L, and the light beam L reaches a reflection body 30 to generate a reflective light beam R. The sensor element 232 then receives the reflective light beam R. The variation between the light beam L and the reflective light beam R can be transformed into a DC signal or a background value through the electronic component 25.

Referring to FIG. 4B, when the user operates the input device 20a, the light-emitting element 231 emits a light beam L, which reaches a reflection body 30′ such as a finger. Since the light refractiveness and refraction angles can be changed according to the blood volume inside the blood vessels, the different reflective light beams R′ and R″ can be obtained. In this case, the sensor element 232 also receives the reflective light beams R′ and R″, and the variation between the light beams can be transformed into an AC signal or a measuring value through the electronic component 25. Then, the electronic component 25 can calculate the physiological measuring results according to the measuring value minus the background value. Moreover, the physiological measuring results can be displayed through a monitor (not shown).

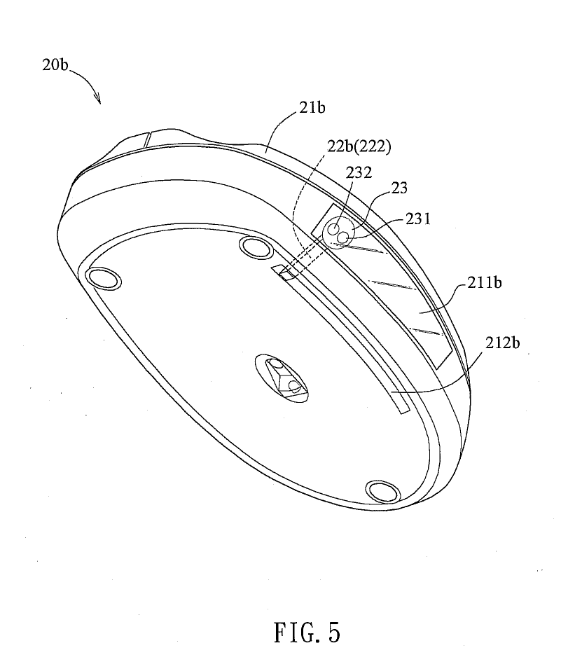

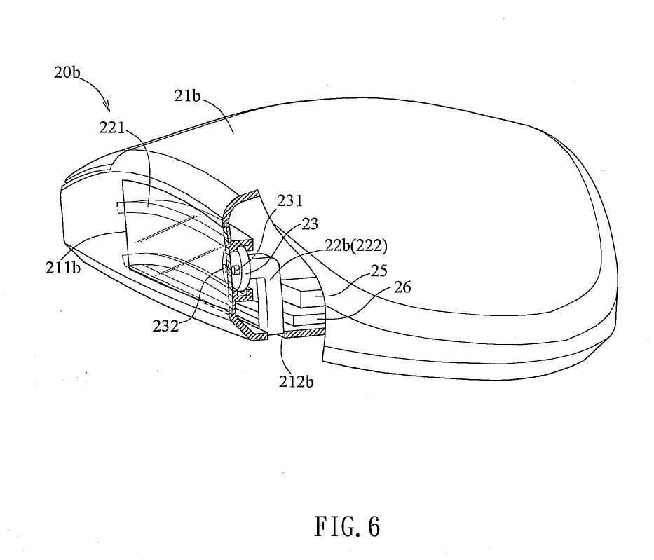

With reference to FIGS. 5 and 6, an input device 20b according to another preferred embodiment of the invention includes a housing 21, a position-adjustable mechanism 22b and a sensor module 23. The input device 20b is also a mouse for example. The housing 21b includes a light-permeable handheld part 211b and an opening 212b disposed adjacent to the light-permeable handheld part 211b. In the embodiment, the opening 212b is disposed on the bottom of the housing 21b.

The position-adjustable mechanism 22b is disposed in the housing 21b, and the position-adjustable mechanism 22b can be moved within the light-permeable handheld part 211b. The sensor module 23 is joined together with the position-adjustable mechanism 22b for traction. Thus, the position of the sensor module 23 can be adjusted to a suitable position according to the position-adjustable mechanism 22b. Since the sensor module 23 has been described in the above embodiment, the detailed description thereof will be omitted.

In the embodiment, the position-adjustable mechanism 22b is a linking rod 222, but not limited to it. The position of the position-adjustable mechanism 22b can be adjusted by shifting, rotating or shifting-rotating.

When the user utilizes the input device 20b to measure the physiological signals, he can adjust the sensor module 23 to a suitable position through the position-adjustable mechanism 22b exposed from the opening 212b. For example, the sensor module 23 can be adjusted to a position corresponding to the thumb of the user. Then, the measurement can be performed so as to ensure the reliability of the measuring results according to the PPG.

In the embodiment, the sensor module 23 can transmit signals to the electronic component 25 through a wireless module (not shown), such as a radio frequency (RF) module or a Bluetooth module. In addition, the power supply of the sensor module 23 can be a battery. When the user utilizes the input device 20a for measurement, his thumb is in touch with the light-permeable handheld part 211b, but not directly contacts the sensor module 23 and the opening 212b. Thus, the input device 20b can provide better handheld feeling and keep the sensor module 23 clean.

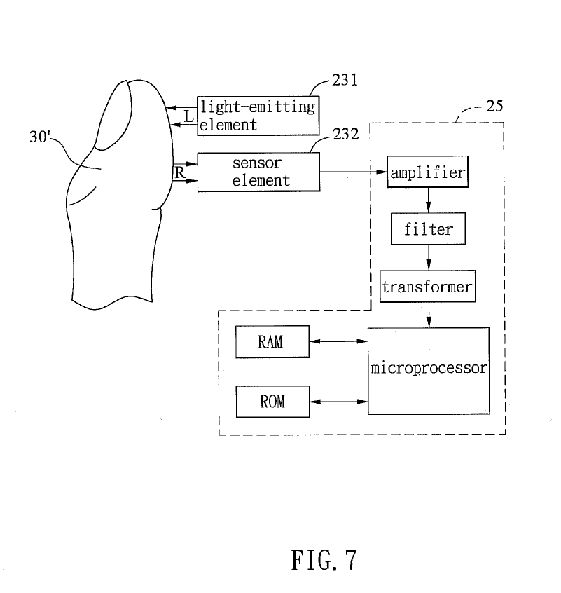

As shown in FIG. 7, the light-emitting element 231 emits a light beam L and the light beam L is reflected by the reflective body 30′ such as a finger. Then, the sensor module 232 receives the reflective light beam R. The signals are outputted from the sensor element 232 to the electronic component 25 for calculation. In the embodiment, the electronic component 25 can be an amplifier, a filter, a transformer, a microprocessor, a ROM, a RAM or their combinations.

To sum up, the input device with the physiological measuring function of the invention can measure the physiological signals of heartbeat, pulse, sweat, skin temperature, blood signal, oxygen saturation (SpO₂), muscle tone or blood pressure, but not limited to these,. When the users have different physiological conditions and habits utilize the input device, the position-adjustable mechanism can be adjusted through the opening. Thus, the sensor module can be adjusted to the suitable position for fitting different users with adding the amount of the sensor modules. In addition, the user does not have to directly contact with the sensor module according to the light-permeable handheld part, so that the surface of the sensor module can be kept clean. Compared with the prior art, the input device of the invention can further overcome the difference in ergonomics and habit so as to ensure the reliability of the measuring results.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An input device with a physiological measuring function, comprising:
a housing having a handheld part and an opening;
a position-adjustable mechanism disposed in the housing, wherein a part of the position-adjustable mechanism is exposed from the opening; and
a sensor module joined together with the position-adjustable mechanism for traction.

2. The input device according to claim 1, wherein the opening is disposed on the handheld part.

3. The input device according to claim 2, wherein the handheld part is disposed on a side surface of the housing.

4. The input device according to claim 2, wherein the sensor module is exposed from the opening.

5. The input device according to claim 1, wherein the opening is disposed on a bottom of the housing.

6. The input device according to claim 5, wherein the handheld part is light permeable.

7. The input device according to claim 1, wherein the sensor module comprises at least one light-emitting element and a sensor element.

8. The input device according to claim 7, wherein the light-emitting element is a light-emitting diode or an organic light-emitting diode.

9. The input device according to claim 7, wherein the sensor element is a photo diode (PD), a charge coupling device (CCD) or a complementary metal-oxide semiconductor (CMOS).

10. The input device according to claim 1 is a mouse.

11. The input device according to claim 1, wherein the opening is a rectangular opening, and the position-adjustable mechanism is adjustably moved within the rectangular opening.

12. The input device according to claim 1, wherein the sensor module and the position-adjustable mechanism are joined together through a linking rod.

13. The input device according to claim 1, wherein the sensor module is a photo plethysmographic (PPG) sensor module.
